(19) United States
(12) Patent Application Publication
(10) Pub. No.: US 2013/0132287 A1
(43) Pub. Date: May 23, 2013

(54) MODEL-BASED SCORING OF COMPARABLE PROPERTIES BASED UPON THEIR APPROPRIATENESS FOR USE AS COMPARABLES FOR A SUBJECT PROPERTY

(71) Applicants: WenXiong W. Yao, Rockville, MD (US); Adam Davis, Arlington, VA (US); Hamilton Fout, Rockville, MD (US); Eric Rosenblatt, Derwood, MD (US); Mark Allan Stewart, McKinney, TX (US)

(72) Inventors: WenXiong W. Yao, Rockville, MD (US); Adam Davis, Arlington, VA (US); Hamilton Fout, Rockville, MD (US); Eric Rosenblatt, Derwood, MD (US); Mark Allan Stewart, McKinney, TX (US)

(73) Assignee: Fannie Mae, Washington, DC (US)

(21) Appl. No.: 13/299,750

(22) Filed: Nov. 18, 2011

(51) Int. Cl. G06Q 50/16

(52) U.S. Cl. 705/306; 705/313

(57) ABSTRACT

Automatically rating comparable properties by accessing property data and comparable assessment information, in which a regression is performed, on to model the relationship between the comparable-appropriateness of the property data and explanatory variables. A set of comparable-appropriateness values for each of the plurality of comparable properties based upon differences in the explanatory variables between the subject property and each of the plurality of comparable properties are chosen and an assessment is outputted.

### BACKGROUND OF THE INVENTION

1. Field of the Invention

This application relates generally to a rating model, more particularly to rate comparable sales (comps) used by an appraiser as part of evaluating the quality of the appraisal, and more particularly to implement the rating model into a Collateral Data Delivery (CDD) portal and the like.

2. Description of the Related Art

The Collateral Data Delivery (CDD) project is a central element to loan initiatives that will assist single family mortgage businesses and enterprise risk management businesses through standardization of data storage, pro-cessing, exchange, modeling, and analytics in effective collateral risk management.

The CDD portal is a repository and risk scoring system that is distinguished from other systems like Desktop Underwrite (DUO) in that the CDD portal will enhance the business community's ability to detect and prevent fraud, form better appraisals, improve data integrity, and reduce repurchase requests. Also, the CDD portal receives digital data and enforces approved standards and policies.

However, the CDD portal lacks appraisal risk models that can effectively handle the challenge of each appraised value being derived from a different approach, such as income approach, cost approach, or sales comparison approach. For example, appraisals based on the sales comparison approach typically include three to six comparable sales while the comparable selection model may determine there are more than 100 available comps from the public record. Thus, the questions that remain unanswered include: How many valid comps can we find for a particular property? Does the appraiser select the representative, good, or relative low-quality comps compared to those identified in the comparable selection model? Do the selected comps create a biased value? How similar is each comp to the subject? Are adjustments consistent with the comparison between subject and comp? Are there any dominant factors that have created a bias? Is the overall appraisal of good quality?

In addition, due to the required extensive database knowledge and access and the time sensitive nature of analyzing such database knowledge, human abilities fall short of the timely database parsing and computing that would permit extensive risk modeling. And since the CDD portal lacks appraisal risk models, as described above, the below described invention offers and details a faster way to judge comp quality without the need for additional human evaluations.

Thus, what is needed is a rating model for the CDD portal and the like that evaluates an individual comp, both comparable selection model comps and appraisal comps, with a consistent and holistic approach that provides near instantaneous computing of extensive database resources.

### SUMMARY OF THE INVENTION

The present invention relates to a method for automatically rating comparable properties that comprises identifying a subject property and a plurality of comparable properties; accessing property data and comparable assessment information that identifies comparable-appropriateness corresponding to the property data of the subject property and the plurality of comparable properties; performing a regression based upon the property data, the regression modeling the relationship between the comparable-appropriateness and explanatory variables; determining a set of comparable-appropriateness values for each of the plurality of comparable properties based upon differences in the explanatory variables between the subject property and each of the plurality of comparable properties; and outputting an assessment of each of the plurality of comparable properties based upon the determined set of comparable-appropriateness values.

Further, the assessment may comprise a quantified score for each of the determined set of comparable-appropriateness values for a given one of the plurality of comparable properties and an overall indication of appropriateness for the given comparable property.

Furthermore, the plurality of comparable properties may be from an appraisal report, and the assessment may comprise an overall indication of appropriateness for each of the plurality of comparable properties in the appraisal report, such that the assessment provides an automatic indication of the quality of the appraisal report. The explanatory variables may include separation distance, gross living area, lot size, age, transaction data time lag, and number of bedrooms. The plurality of comparable properties that are from an appraisal report may also comprise determining that the appraisal report implements a special adjustment for at least one of the plurality of comparable properties, the special adjustment corresponding to a characteristic that is not represented by the explanatory variables; and adjusting the assessment of at least one of the plurality of comparable properties based upon an adjustment value associated with the characteristic. In addition, the method may include determining a geographical area for the appraisal report, and determining a weight for the adjustment value based upon a predetermined impact of the characteristic particular to the geographical area.

Alternative embodiments may be include a computer program product stored on a non-transitory computer readable medium that when executed by a computer performs a method for automatically rating comparable properties, an apparatus that rates comparable properties, and a system that automatically rates comparable properties.

The described may be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the described are more fully disclosed in the following specification, reference being had to the accompanying drawings, in which:

FIGS. 1A-B are block diagrams illustrating examples of systems in which a comparable rating application operates.

FIG. 2 is a flow diagram illustrating a method for automatically rating comparable properties.

FIG. 3 is a graph detailing a distribution of ratings.

FIG. 4 is a pie chart detailing a contribution of variables.

FIG. 5 is a block diagram illustrating an example of a comparable rating application.

FIG. 6 is a block diagram illustrating an example of a comparable rating application with a geographic feature for proximity determination.

### DETAILED DESCRIPTION OF THE INVENTION

In the following description, for purposes of explanation, numerous details are set forth, such as flowcharts and system configuration, to provide an understanding of one or more embodiments. However, it is and will be apparent to one skilled in the art that these specific details are not requited to practice the described.

According to one aspect, an application constructed via software that is stored on a non-transitory computer readable medium may perform a method for automatically rating comparable properties that accesses property data and comparable assessment information to perform a regression to model a relationship between the comparable-appropriateness of the property data and explanatory variables.

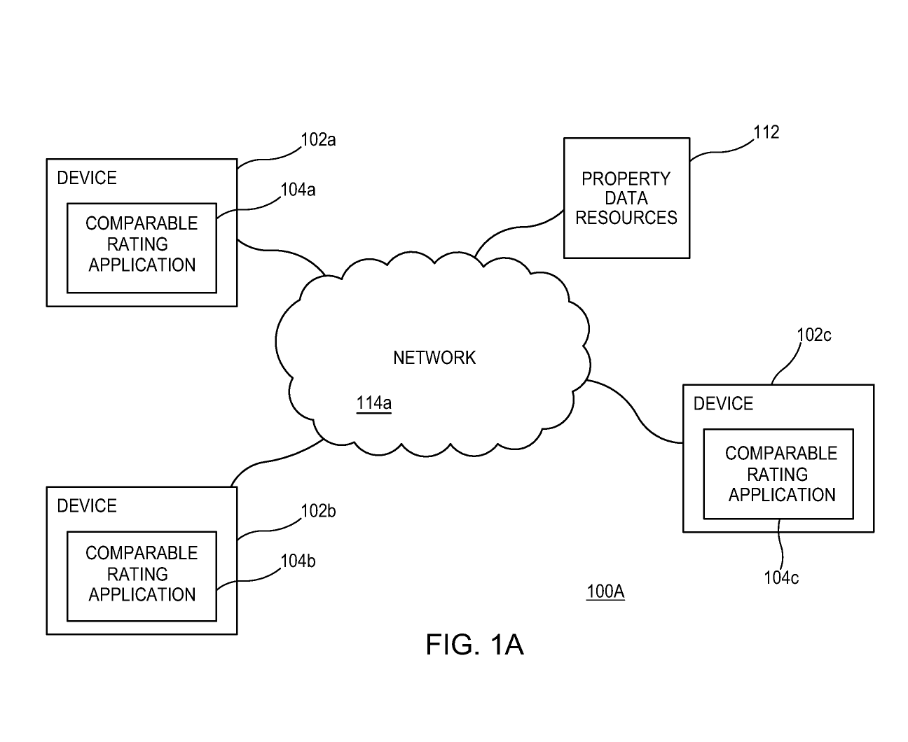

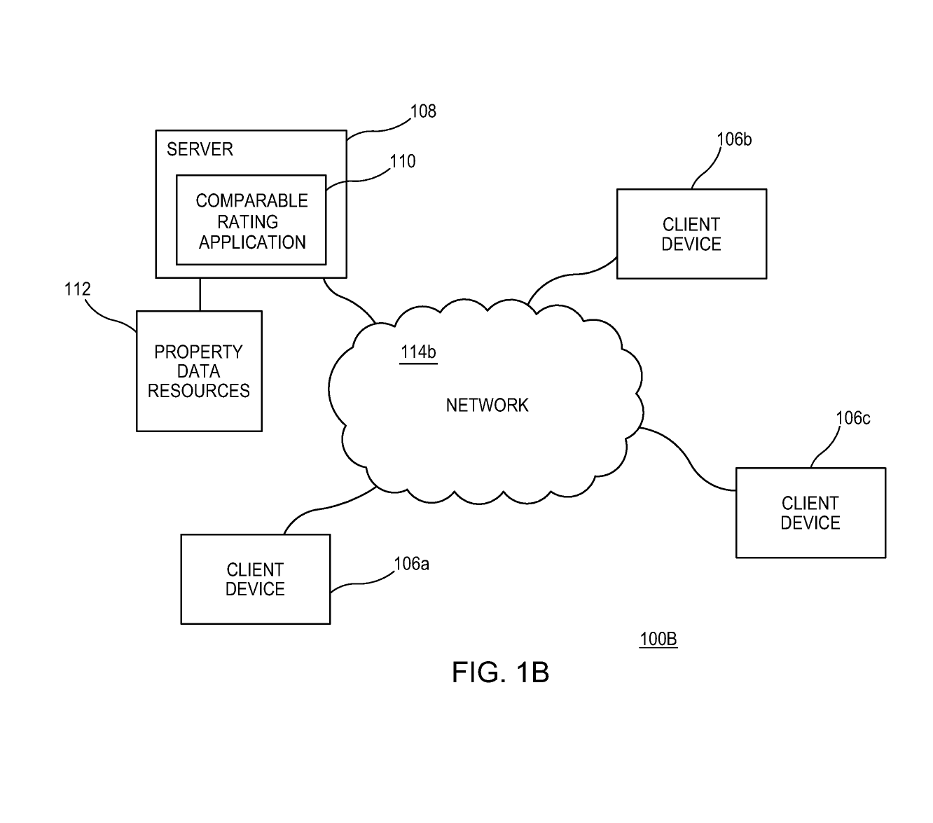

FIGS. 1A-B are block diagrams illustrating examples of systems in which a comparable rating application operates. Specifically, FIGS. 1A-B are block diagrams illustrating examples of systems 100A-B in which comparable rating applications 104a-c and 110 operate.

FIG. 1A illustrates several devices 102a-c each having a comparable rating application 104a-c installed thereon. The devices 102a-c are preferably computer devices, which may be referred to as workstations, although they may be any conventional computing or electronic device, such as personal computers, laptop personal computers, mobile phones, smart-phones, super-phones, tablet personal computers, personal digital organizers, and the like. Further, for example, the devices 102a-c may be configured with a web browser application, with the application configured to run in the context of the functionality of the browser application. This configuration may also implement a network architecture wherein the comparable rating applications 104a-c provide, share, and rely upon the functionality of other applications. Further, the network 114a over which the devices 102a-c communicate may also implement any conventional technology, including but not limited to cellular, WiFi, WLAN, LAN, or combinations thereof.

FIG. 1B illustrates several client devices 106a-c each having access to a server 108 with a comparable rating application 110 installed thereon. Access by the client devices 106a-c to the server 108 and application 110 may be performed through conventional web browsing. Further, the functionality may be divided between the client devices 106-a-c and server 108 across a network 114b, which may be configured similarly to network 114a.

As illustrated in FIGS. 1A-B, property data resources 112 are typically accessed externally for use by the comparable rating application, since the amount of property data is rather voluminous, and since the application is configured to allow access to any county or local area in a very large geographic area (e.g., for an entire country such as the United States). Additionally, the property data resources 112 are shown as a singular block in the figure, but it should be understood that a variety of resources, including company-internal collected information (e.g., as collected by Fannie Mae), as well as external resources, whether resources where property data is typically found (e.g., MLS, tax, etc.), or resources compiled by an information services provider (e.g., Lexis). The comparable rating application accesses and retrieves the property data from these resources in support of the modeling of comparable properties (comps).

The comparable rating application, in modeling and rating comps, is predicting the viability of the comps. The rating may be used to verify previously expert selected appraisals, that is, to control and minimize the human errors regarding selection of an appraisal where an expert selected an appraisal that may not be the best fit for a subject or to more methodically select and compute explanatory variable associated with the comps where the expert mistakenly missed a variable. Further, override rules may be adopted to account for comps that may or may not be selected by an expert due to the impact of either extreme value or data elements not commonly available, such as material adjustments for a comp regarding basement, view, and condition.

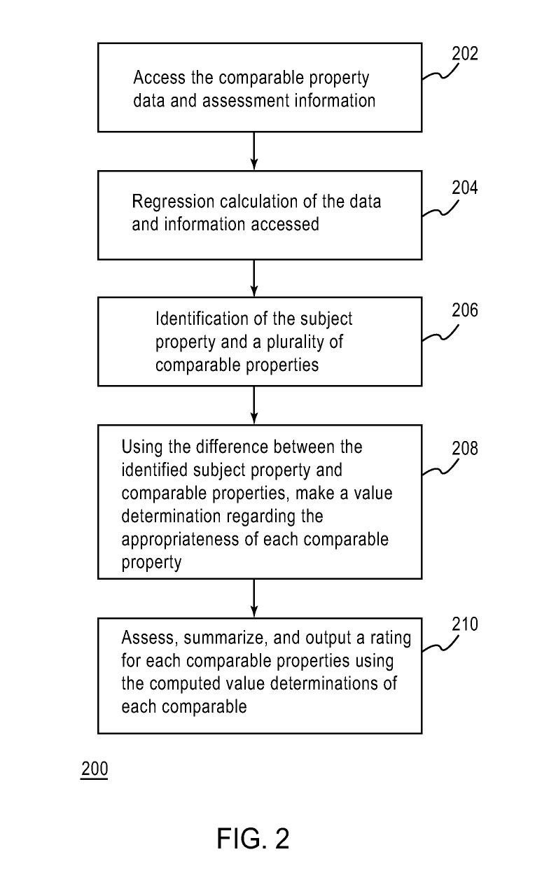

The comparable rating model can rate comparables regardless of the market type. That is, the comparable rating model is fit to rate comparables in both a heterogeneous urbanized market, such as Washington D.C., and a sub-urban market (and sometimes rural market), such as Dallas. For example, FIG. 2 is a flow diagram illustrating a method for automatically rating comparable properties. Specifically, FIG. 2 implements the comparable rating process 200 (i.e. executes the comparable rating application 104a-c or 110) by accessing 202 property data and comparable assessment information from the property data resources described above to identify the comparable-appropriateness of the comps to the subject based on the property data. Note, it is preferable that after data is accessed 202 and regressed 204, as described below, a comp list is identified or built relative to a subject according to the data processed that was accessed and regressed, because having such data processed before a subject is inputted may enhance the comp rating speed. Alternatively, a subject may also be initially inputted into the model and the data processed post input. Thus, the described steps (202-206) are interchangeable and even may be done simultaneously.

Then, a regression 204 based upon the property data pooled from the property data resources is performed where the regression models the relationship between the comparable-appropriateness and explanatory variables. That is, current appraisals provide readily available comparable property data, such as distance (Distance), age of the property (Age), time lag (Timelag), Gross Living Area (GLA), Lot Size (Lot), and number of bedrooms (Bedroom) that may be incorporated in the comparable rating model as explanatory variables. On any appraisal, most of the comparable property data can be used as explanatory variables.

Distance or location is often considered the most important explanatory variable. Thus, determining what is a similar location is one of the most significant challenges in reviewing the validity of a comparable sale. Subdivision name, neighborhood name, schools, school district, and county are all metrics that may be implemented in the model, but for varying reasons the preferred solution is geographical distance. That is, correlating geographic distance with lot size may determine the relative value of a comp. In geographic areas with smaller lot sizes or zones, geographical distance may prove the most effective, as school district and other property characteristics may be the same. Further, properties with similar size lots tend to be clustered together; therefore, larger lot neighborhoods are generally larger geographically, and smaller lot neighborhoods are smaller. When comparing these principals to the designations urban, suburban, and rural, it is found that because there is no clear definition for urban, suburban, and rural in practice, as proven through the inconsistent selection of these designations and because of developmental pockets, distance by lot size is a partial substitute. Thus, correlating distance with lot size is preferred.

Age of the property, that is, age difference comparison of the subject property to the comparable sale, may also be used as an explanatory variable. Yet this variable presents its own complications. For example, consider a simple absolute value difference method. Generally, there is limited difference in buyer perception due to age for a property that was built in 1900 when compared with a home built in 1920, even though there is an absolute value difference of 20 years. Then consider the same absolute value difference of 20 years for a property built in 2005 versus 1985. The later possesses a clear difference in buyer perception. Percentage difference is a suggested alternative method to calculate an age difference comparison, but the dramatic percentage changes at the lower end of the numerical spectrum make this system somewhat impractical. The preferred resolution is to create age cohorts, and define limitation based on the cohorts. In other words, creating time periods for when a house was built where the time period range decreases as the period approaches the present time may define the cohort is preferred.

A time lag comparison of the subject property to the comparable sale may also be used as an explanatory variable. Time lag references the number of days from the effective date of the appraisal until the settled date of the comparable sale. This is straightforward. That is, properties may be preferred if settled within 90 days of the effective date, deemed adequate if within 180 days, and deemed poor if 180 days is exceeded.

A Gross living area (GLA) comparison of the subject property to the comparable sale may also be used as an explanatory variable. GLA may be limited to a finished living area above grade that is completed to the standards of the neighborhood and is legally permitted by the local municipality. Every appraisal is required to have the GLA defined for the subject and compared to the defined area of the comparable. It is preferred to distinguish the requirement that a direct comparison of GLA is required and should not include unfinished space, or below grade living area in the calculations.

Lot Size may also be used as an explanatory variable and is generally a straight forward number when the information is entered correctly for a given comparable property.

The number of bedrooms, that is, a bedroom difference comparison of the subject property to the comparable sale, may also be used as an explanatory variable. That is, the difference in the number of bedrooms (or bedroom count comparisons) fundamentally impacts a buyer's decision to pursue a property or not. When most buyers consider homes they think terms of bedrooms and bathrooms, not in terms of GLA. However, as the number of bedrooms increase the appeal difference between properties decreases. This is due to the desired functional utility of the owner. There are clear market divides between 1, 2, and 3 bedroom homes, regardless of the different categories of rental apartments, condos, co-ops, and single family homes. Yet, it is safe to assume that a large number of the 0-2 bedroom housing unites are not single family homes. With that said, there is a significant difference in the value and appeal of a two-bedroom versus a three-bedroom, but little to no difference between a three-bedroom and four-bedroom.

Other property data, such as the adjustments on the appraisal form can be used if available. Among the characteristics used for adjustments, some data, such as view and basement, may be good quality for model processing; however, others adjustments may be incomplete or noisy.

Thus, comparable rating process accesses 202 property data and comparable assessment information from the property data resources described above to identify the comparable-appropriateness of the comps to the subject based on the property data, while a regression 204 calculation of the data and information access models the relationship between the comparable-appropriateness and explanatory variables.

That is, after accessing 202 property data and comparable assessment information, the process continues by selecting a set of explanatory variables, excluding a comparables based on a threshold regression value, and performing a rating regression on the comparable set. These steps are interchangeable. That is, the exclusion may alternatively occur after or during the performance of the regression calculation or selecting of the set of explanatory variables. The excluding of comparable properties removes comps that have outliers beyond pretested cutoffs from the total process.

For example, a test comparable rating application accessed and indentified in relation to a subject property a sample of 1077 comparable properties located in Washington D.C. and Dallas form a set of property data resources. Exclusions due to lack of geographic information, to subject age missing, to listing Comps, and to lack of low size information were applied to the 1077 pool of comps. Further exclusions, such as basement, age (new construction), and lot size (greater than 3 acres), were applied to eliminate extreme comps and to provide a reasonable and consistent pool. The final sample contained 713 comps (see Table 1).

TABLE 1
Data used in the Comparable Rating Model

| Data Exclusions | DC | Dallas | All |
|---|---|---|---|
| Total Number of Comps | 551 | 526 | 1077 |
| Exclusion due to lack of geographic information | 30 | 17 | 47 |
| Exclusion due to subject age missing | 0 | 3 | 3 |
| Exclusion due to listing Comps | 42 | 154 | 196 |
| Exclusion due to lack of lot size information | 3 | 23 | 26 |
| Subtotal | 476 | 329 | 805 |
| Excluding Subject and Comp having basement | | 19 | 19 |
| Excluding New Subject or Comp | 11 | 29 | 40 |
| Excluding Comps with lot size >3 Acres | 33 | 0 | 33 |
| Final Sample used in the model | 432 | 281 | 713 |

A regression calculation of the final sample (713 comps) models the relationship between the comparable-appropriateness and explanatory variables. That is, when the comparable rating application accesses electronic appraisals relative to a subject property that is being valued, and in evaluating those appraisals, whether the appraisals are locally or remotely stored, the comparable rating application ranks or scores individual comparables based on the selected explanatory variables, for both model and appraisal comparables.

When the process performs a regression calculation on the comparable set by a comparable's similarities to the subject or using exclusions or cutoffs to rank or rate the comparables, the following regression may be used:

$$Comp score = {\sum }_{i = 1}^{n} χβ ( {Δ}_{i} ) , \qquad ( Eq . 1 )$$

where ‘n’ is an integer representing a number of explanatory variables from the set of explanatory variable used in the rating regression, β is the coefficient estimate, and Δᵢ represents each explanatory variable ‘i’ to ‘n’ from the set of explanatory variables. That is, even though any number of explanatory variables may be used, it is preferred the process or model uses data commonly found on appraisal forms, such as the above described distance (Distance), age of the property (Age), time lag (Timelag), Gross Living Area (GLA), Lot Size (Lot), and number of bedrooms (Bedroom). The preferred model does not exclude the other explanatory variables, such as all of the adjustments on the appraisal form, providing they are available. Two additional explanatory variables may be, for instance, view and basement condition.

When the explanatory variables listed above are used in the regression and when n=6, such that Distance=Δ₁, Age=Δ₂ Timelag=Δ₃, GLA=Δ₄ Lot=Δ₅ and Bedroom=Δ₆) then the following regression is performed:

CompScore=Intercept+Xβ(Distance)+Xβ(Age)+Xβ(Timelag)+Xβ(GLA)+Xβ(Lot)+Xβ(Bedroom) (Eq. 2)

Further, there may be times where a comparable should not be removed or the comparable possesses an outlying explanatory variable. In these instances, it may be proper for the comparable rating process to perform an adjustment by overriding a score based on the distance from the normal range. That is, sometimes the dominant factors will impact the rating of a comparable, and to handle those dominant factors, override rules are employed. Each rule should specify a dominant factor, and if a threshold is triggered, action will be taken to push the score of the comparable to a different level.

After the regression 204 calculation is performed, the comparable rating process 200 identifies 206 a subject property and a plurality of comparable properties. More specifically, identification is a selection of comps relative to a target. Through identification 206, the comparable rating process 200 has a new pool of properties, which include the subject, for which to compare and rate. These steps (202-206) are interchangeable or may be done simultaneously. Further, selection of identification is preferred to be automatically performed by the comparable rating process 200, yet it is possible using a graphic user interface to permit a user to see, or verify the identified comps. That is, using a graphic user interface the comparable rating process may have an automotive pause function that allows manipulation of the identified subject (for example, through insertion of a new subject or altering of the current subjects properties) or comps (for example, though individual selection or addition) by another part of the comparable rating process, an external device to the process, or a user.

Using the identified subject property and plurality of comparable properties, the comparable rating process determines 208 a set of comparable-appropriateness values for each of the plurality of comparable properties based upon differences in the explanatory variables between the subject property and each of the plurality of comparable properties. For example, the following methods may be used when calculating the explanatory variables differences (for GLA, Lot Size, and Bedroom) between the subject property and the plurality of comps. Thus, GLA difference may be defined as:

$$G L A difference \% = \frac{\vert difference on the G L A \vert}{Minimal G L A of Subject and Comp} \qquad ( Eq . 3 )$$

To capture the impact of many more outliers in property space, GLA difference % may also be used as a continuous variable. The Lot Size difference may be defined as:

$$Lot Size difference \% = \frac{\vert difference on the Lot Size \vert}{Minimal Lot Size of Subject and Comp} \qquad ( Eq . 4 )$$

For the very same reason as GLA difference %, Lot difference % may be used as a continuous variable. As described above, a bedroom difference comparison of the subject property to the comparable sale may also be used as an explanatory variable. That is, the difference in the number of bedrooms or bedroom count comparisons fundamentally impact on buyer's decision to pursue a property or not, and because there is a significant difference in the value and appeal of a two-bedroom versus a three-bedroom, but little to no difference between a three-bedroom and four-bedroom it is preferred that a percentage calculation is used for accounting for the market's non-linear reaction to bedroom count. That is the variation in the number of bedrooms may be defined as:

$$bedroom difference \% = \frac{\vert difference on the number of bedrooms \vert}{Minimal number of bedrooms} \qquad ( Eq . 5 )$$

The differences or similarities of the above explanatory variables between the comps and the subject are used to evaluate the quality of a comparable. Further, the explanatory variables may be formatted to specific buckets or used as continuous variables. The use of continuous variables was considered when the distribution of the property universe was likely to be very noisy. Also, when an explanatory variable is noisy, such as incorrectly entered data on the appraisal, missing data, or data that simply does not closely correlate, the comparable with this noisy data may be excluded.

In the comparable rating process 200, the comparable rating process finishes rating the comp (or comps) by evaluating the comp based on the accumulated rating of the comparables, adjustments, and overrides and outputs 210 an assessment of each of the plurality of comparable properties based upon the determined set of comparable-appropriateness values. In other words, according to one aspect, the proposed process ranks comps by their risk and sets the threshold for rejection or acceptance of the comp itself. Thus, in ranking the comps with the described process, the challenge of an appraisal and its listed comps value being derived using one of the sales comparison, cost, and income approaches exists is addressed with the above consistent and holistic approach.

Specifically regarding overrides, override rules may be implemented to eliminate dominate factors that impact comp ratings. For instance, there may be a rule to account for view adjustments. If there is an adjustment for view on the appraisal form, the form will show that there is a clear difference in the view between the subject and the comparable. Since view can cause a significant value difference, view adjustments are treated as an individual override rule.

Further, there may be a rule to account for basement adjustments. Basements can add significant appeal to homes and dramatically change the value of a property depending on the level of finish, improvement, and functional utility of the space. However, basements are not commonly uniform throughout the country and have varying appeal by region. A look into the regionality of basements and their impacts on value, acceptability, and commonality will follow as they pertain to their relevance to valuation.

In the areas where basements are less common, basement remodels have a high return on investment. That is, investments in basements in these areas may provide a better return upon resale, than in areas where basements are thought to be more widely accepted. In many portions of the country, basements are uncommon and are rarely a factor in the valuation process. Because there is an acceptance of below grade living space in these areas and because when they exist they substantially contributory in terms of value, it is important for the comparable rating process to determine the existence of a basement, as well as the reasonableness of the adjustment feature. Thus, basement adjustments are treated as an individual override rule.

Furthermore, there may be rules to account for other adjustments. The ideal comparable sale to use is identical to the subject in all its physical characteristics, in the same neighborhood, and settled recently enough to reflect no apparent market differences for time. It is rare that this ideal is available, let alone three times minimum for each property that is appraised. For that reason, making adjustments to the sales price of the comparable to reflect the appeal differences with the subject is preferred. Some comparables require the least adjustment, while sales that have different appeal to the market than the subject require more substantial adjustment.

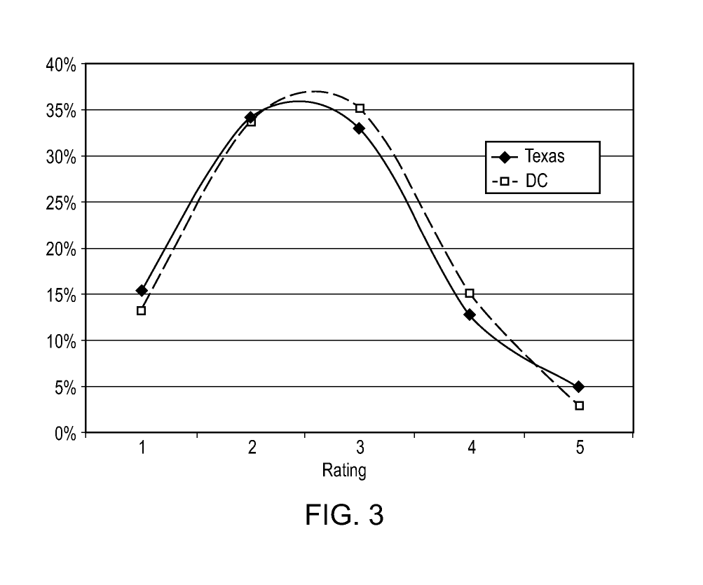

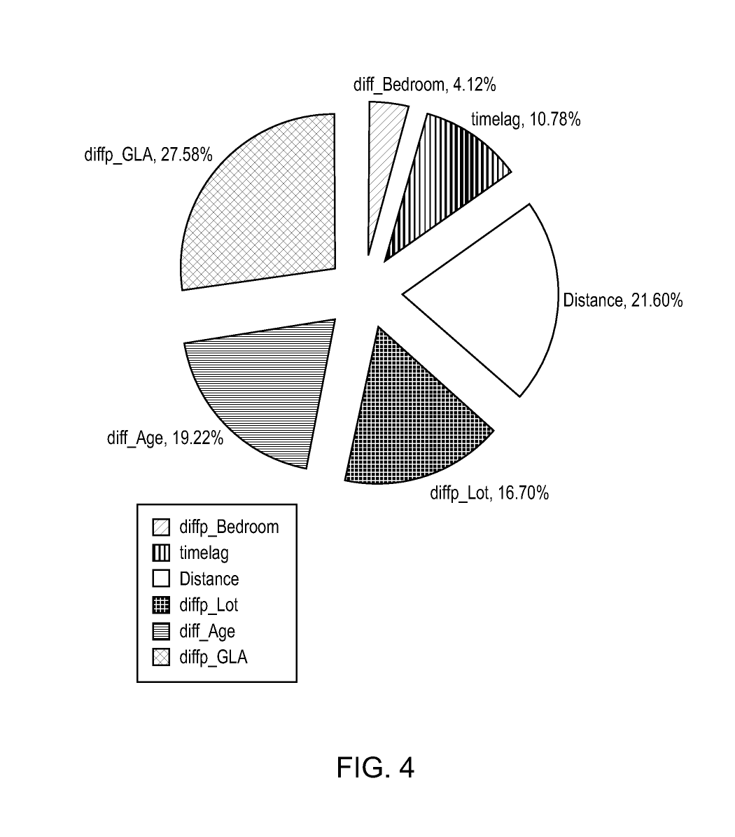

Returning to the example of the comparable rating application where the final sample contains 713 comps with all the appropriate information pulled from the resources and the above various exclusions applied, FIG. 3 is a graph detailing a distribution of ratings. That is, after the above process was applied to the 713 comps, it was found that the ratings follow a normal distribution where the majority are 3's and fewer are 1's and 5's, as show in FIG. 3. In addition, because some comps required multiple rating, the total number exceeded the number of comps that were in the sample set (i.e. 713 comps). Furthermore, the final sample pool was analyzed for specific property data frequency and variable contribution. FIG. 4 is a pie chart detailing a contribution of variables. It was found that current appraisals provide readily available comparable property data, such as distance (Distance), age of the property (Age), time lag (Timelag), Gross Living Area (GLA), Lot Size (Lot), and number of bedrooms (Bedroom), that may be incorporated in the comparable rating model as explanatory variables. Other property data, such as the adjustments on the appraisal form can be used if available. Among the characteristics used for adjustments, some data, such as view and basement, may be good quality for model processing; however, others adjustments may be incomplete or noisy. As explained below, overrides may be used to account for poor quality explanatory variables.

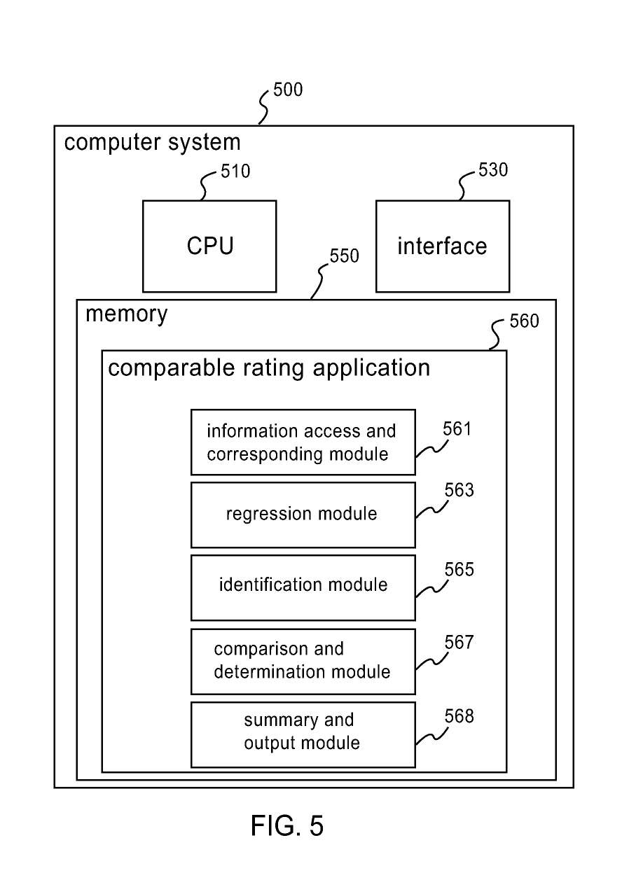

As stated above, the present invention may be preferably provided as an application or as software, yet it may alternatively be hardware, firmware, or any combination of software, hardware and firmware. Of course, a single computing device may be independently configured to include the comparable rating application. FIG. 5 is a block diagram illustrating an example of a comparable rating application. Specifically, FIG. 5 is a block diagram illustrating an example of a computer system 500 in which the comparable rating application 560 operates. FIG. 5 illustrates a computer system 500, which includes a central processing unit (CPU) 510, an interface 530, and a memory 550. The computer system 500 may be a conventional desktop computer, a network computer, a laptop personal computer, a handheld portable computer (e.g., tablet, PDA, cell phone) or any of various execution environments that will be readily apparent to the artisan and need not be named herein. The interface 530 may be any interface suited for input and output of communication data, whether that communication is visual, auditory, electrical, transitive, or the like. In addition, server 108, devices 102a-c, and client devices 106a-c may be similarly configured to the above described computer system 500.

The computer system 500 runs a conventional operating system through the interaction of the CPU 510 and the memory 550 to carry out functionality by execution of computer instructions. The memory 550 may be any memory suitable for storing data, such as any volatile or non-volatile memory, whether virtual or permanent. Operating systems may include but are not limited to Windows, Unix, Linux, and Macintosh. The computer system may further implement applications that facilitate calculations including but not limited to MATLAB. The artisan will readily recognize the various alternative programming languages and execution platforms that are and will become available, and the present invention is not limited to any specific execution environment.

In one embodiment, a computer system 500 includes the comparable rating application 560 resident in memory 550, with the comparable rating application 560 including instructions that are executed by the CPU 510. That is, the comparable rating application 560 is preferably provided as software, yet it may alternatively be hardware, firmware, or any combination of software, hardware and firmware. Alternative embodiments include an article of manufacture wherein the instructions are stored on a non-transitory computer readable storage medium. The medium may be of any type, including but not limited to magnetic storage media (e.g., floppy disks, hard disks), optical storage media (e.g., CD, DVD), and others. Still other embodiments include computer implemented processes described in connection with the comparable rating application 560, as well as the corresponding flow diagrams.

The comparable rating application 560, according to the present invention, may have an information access and corresponding module 561, a regression module 563, an identification module 565, a comparison and determination module 567, and a summary and output module 568 to implement the comparable rating. Further, other application modules not shown in FIG. 5, but described through the specification, may also be implemented.

The information access and corresponding module 561 may access its own internal property data resources or communicate via the interface 530 with external property data resources to identify the comparable-appropriateness of the comps to a subject. Further, the regression module 563 may perform a regression calculation of the data accessed by the information access and corresponding module 561 to model the relationship between the comparable-appropriateness and explanatory variables.

The identification module 565 may identify a subject property and a plurality of comparable properties. More specifically, the identification module may provide a new pool of properties, which include the subject, for which to compare and rate.

The comparison and determination module 565 may use the identified subject property and plurality of comparable properties to determine 208 a set of comparable-appropriateness values for each of the plurality of comparable properties based upon differences in the explanatory variables between the subject property and each of the plurality of comparable properties.

The summary and output module 568 may provide an assessment of each of the plurality of comparable properties based upon the determined set of comparable-appropriateness values. Also, the summary and output module 568 may output the assessment via the interface 530 to a display device that is either internal or external to the computer system 500. The display device may further be any device that displays an image, which is described below, to a user, such as a light-emitting diode display, a liquid crystal display, an organic light-emitting diode display, a plasma display, and a cathode-ray display.

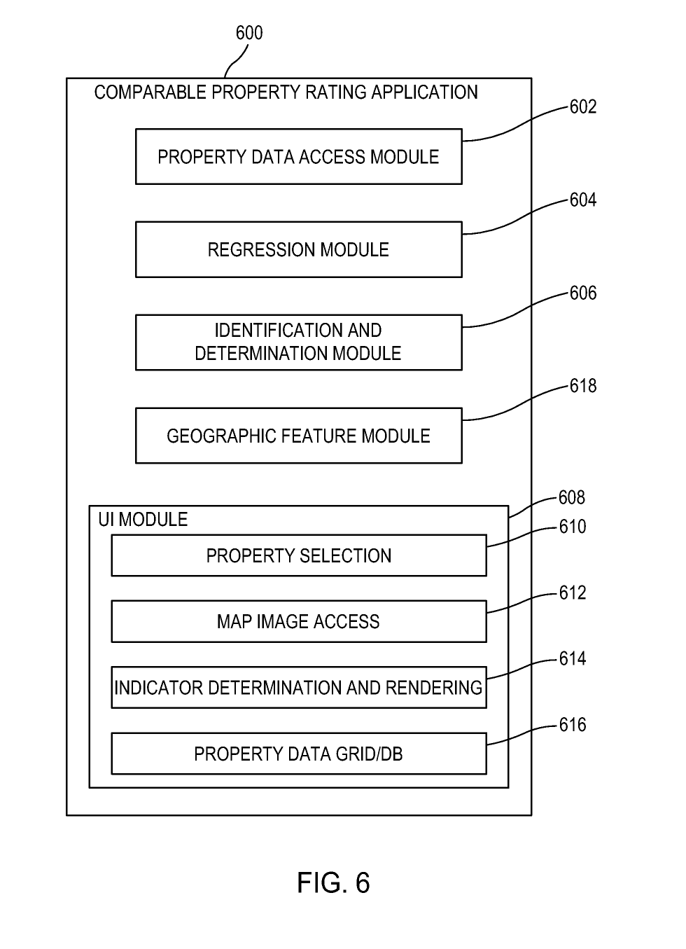

FIG. 6 is a block diagram illustrating an example of a comparable rating application with a geographic feature for proximity determination. Specifically, FIG. 6 is a block diagram illustrating an example of a comparable property rating application 600. The comparable property rating application 600 preferably comprises program code that is stored on a computer readable medium (e.g., compact disk, hard disk, etc.) and that is executable by a processor to perform operations in support of modeling and mapping comparable properties.

According to one aspect, the application includes program code executable to perform operations of accessing property data corresponding to a geographic area, and performing a regression based upon the property data, with the regression modeling the relationship between price and explanatory variables. A subject property and a plurality of comparable properties are identified, followed by determining a set of value adjustments for each of the plurality of comparable properties based upon differences in the explanatory variables between the subject property and each of the plurality of comparable properties. An economic distance between the subject property and each of the comparable properties is determined, with the economic distance constituted as a quantified value determined from the set of value adjustments for each respective comparable property. Once the properties are identified and the adjustments are determined, there is a weighting of the plurality of comparable properties based upon the appropriateness of each of the plurality of comparable properties as comparables for the subject property, the weighting being based upon one or more of the economic distance from the subject property, geographic distance from the subject property, and age of transaction.

The comparable property rating application 600 also includes program code for displaying a map image corresponding to the geographic area, and displaying indicators on the map image indicative of the subject property and at least one of the plurality of comparable properties, as well as ranking the plurality of comparable properties based upon the weighting, and displaying a text listing of the plurality of comparable properties according to the ranking. Finally, the application is configured to receive input indicating selection of comparable properties and to update the map images and indicators as described.

The comparable property rating application 600 is preferably provided as software, but may alternatively be provided as hardware or firmware, or any combination of software, hardware and/or firmware. The comparable property rating application 600 is configured to provide the comparable property modeling and mapping functionality described herein. Although one modular breakdown of the comparable property rating application 600 is offered, it should be understood that the same functionality may be provided using fewer, greater or differently named modules.

The example of the comparable property rating application 600 of FIG. 6 includes a property data access module 602, regression module 604, identification and determination module 606, geographic feature module 618, and UI module 608, with the UI module 608 further including a property selection module 610, map image access module 612, indicator determining and rendering module 614 and property data grid/DB module 616.

The property data access module 602 includes program code for carrying access and management of the property data, whether from internal or external resources. The regression module 604 includes program code for carrying out the regression upon the accessed property data, according to the regression algorithm described above, and produces corresponding results such as the determination of regression coefficients and other data at the country (or other) level as appropriate for a subject property. The regression module 604 may implement any conventional code for carrying out the regression given the described explanatory variables and property data.

The identification and determination module 606 is configured to identify a subject property and a plurality of comparable properties and to determine a set of comparable-appropriateness values for each of the plurality of comparable properties based upon differences in the explanatory variables between the subject property and each of the plurality of comparable properties.

The geographic feature module 618 manages the identification of geographic features, processing of rendered shapes for the geographic features, and application of logic and corresponding determinations whether properties are proximate to the geographic features, such as through the functionality described in connection with FIG. 2 above.

The UI module 608 manages the display and receipt of information to provide the described functionality. It includes a property selection module 610, to manage the interfaces and input used to identify one or more subject properties, from which a determination of the corresponding geographic area is determined in support of defining the scope of the regression and other functionality. The map image access module 612 accesses mapping functions and manages the depiction of the map images as well as the indicators of the subject property and the comparable properties. The indicator determination and rendering module 614 is configured to manage which indicators should be indicated on the map image depending upon the current map image, the weighted ranking of the comparables and predetermined settings or user input. The property data grid/DB 616 manages the data set corresponding to a current session, including the subject property and pool of comparable properties. It is configured as a database that allows the property data for the properties to be displayed in a tabular or grid format, with various sorting according to the property characteristics, economic distance, geographic distance, time, etc.

According to another aspect, mapping and analytical tools that implement the comparable rating application are provided, where the comparable rating application may render map images of subject properties and corresponding comparable properties and output the images and supportive data (e.g., in grid form) in association with the map images to a display. That is, mapping features allow the subject property and comparable properties to be concurrently displayed. Additionally, a table or grid of data for the subject and comparable properties is concurrently displayable so that they can be manipulated, with the indicators on the map image updating accordingly.

For example, mapping features include the capability to display the boundaries of census units, school attendance zones, neighborhoods, as well as statistical information such as median home values, average home age, etc. The mapping features also accommodate the illustration of geographical features of interest along comparable properties, offering visual depiction of properties that border the feature.

The grid/table view allows the user to sort the list of comparables on rank, value, size, age, or any other dimension. Additionally, the rows in the table are connected to the full database entry as well as sale history for the respective property. Combined with the map view and the neighborhood statistics, this allows for a convenient yet comprehensive interactive analysis of comparable sales.

As stated above, an application of the comparable property rating process is to implement it into the Collateral Data Delivery CDD portal to evaluate appraisals at the front end. The CDD regulates how data is standardized, submitted and received, processed, stored and used by relevant industries, and the CDD embodies the strategic objectives of enhancing the ability to detect and prevent fraud, rendering better appraisals to avoid future credit losses, improving data integrity related to property valuation, and reducing and eliminating lender purchase request at the front end. Further, the CDD portal receives data, enforces data standards, eligibility policy, and risk scoring. The CDD portal, also, uses completeness rules and scores as a means for enforcing data standardization; compliance rules and scores as a means to enforce compliance with regulatory requirements and industry policies; appraisal red flag messaging as a means to inform possible fraud candidates; and risk scoring as a means to evaluate comparables and appraisals to identify bad appraisals. In general, when the CDD implements the described comparable rating as a threshold rating for appraisal risk models, i.e. as the risk scoring means or rank order appraisals by their comparable rank, then the CDD can more effectively and more particularly evaluating the quality of the appraisal.

It is also very likely that all CDD models will be used by business and analytic users at the backend also, simply to have consistent policies. Further, risk scoring and messaging based on CDD-Comp Scorecard models should be in real time. That is, since it will be a variable policy tool, it should be implemented without confusion and with minimal efforts and maximal efficiency. Otherwise, quality control will be problematic.

In addition, the CDD portal is not the only system that may implement a comparable rating application or comparable rating model, and an artisan would recognize parallel systems that the above described would be applicable to. Specifically, another application may be to implement the model in a research environment for internal users (i.e., P-CAT). The CDD-comp rating models will be accessible to SAS users and also to business users through web applications like Appraisal Lang Property Home Analytics (Alpha). Once the model is implemented, it will be a part of appraisal analytics suites to generate messaging and risk scores.

Thus, embodiments of the described produce and provide methods and apparatus for rating model for the CDD portal and the like. Although the described is detailed considerably above with reference to certain embodiments thereof, the invention may be variously embodied without departing from the spirit or scope of the invention. Therefore, the following claims should not be limited to the description of the embodiments contained herein in any way.

1. A method for automatically rating comparable properties, the method comprising:
identifying a subject property and a plurality of comparable properties;
accessing, by a computer, property data and comparable assessment information that identifies comparable-appropriateness corresponding to the property data of the subject property and the plurality of comparable properties;
performing a regression based upon the property data, the regression modeling the relationship between the comparable-appropriateness and explanatory variables;
determining a set of comparable-appropriateness values for each of the plurality of comparable properties based upon differences in the explanatory variables between the subject property and each of the plurality of comparable properties; and
outputting an assessment of each of the plurality of comparable properties based upon the determined set of comparable-appropriateness values.

2. The method of claim 1, wherein the assessment comprises a quantified score for each of the determined set of comparable-appropriateness values for a given one of the plurality of comparable properties.

3. The method of claim 2, wherein the assessment further comprises an overall indication of appropriateness for the given comparable property.

4. The method of claim 1, wherein the plurality of comparable properties are from an appraisal report, and the assessment comprises an overall indication of appropriateness for each of the plurality of comparable properties in the appraisal report, such that the assessment provides an automatic indication of the quality of the appraisal report.

5. The method of claim 1, wherein the explanatory variables include separation distance, gross living area, lot size, age, transaction data time lag, and number of bedrooms.

6. The method of claim 1, wherein the plurality of comparable properties are from an appraisal report, further comprising:
determining that the appraisal report implements a special adjustment for at least one of the plurality of comparable properties, the special adjustment corresponding to a characteristic that is not represented by the explanatory variables; and
adjusting the assessment of at least one of the plurality of comparable properties based upon an adjustment value associated with the characteristic.

7. The method of claim 6, further comprising:
determining a geographical area for the appraisal report, and determining a weight for the adjustment value based upon a predetermined impact of the characteristic particular to the geographical area.

8. A computer program product stored on a non-transitory computer readable medium that when executed by a computer performs a method for automatically rating comparable properties, the method comprising:
identifying a subject property and a plurality of comparable properties;
accessing, by the computer, property data and comparable assessment information that identifies comparable-appropriateness corresponding to the property data of the subject property and the plurality of comparable properties;
performing, by the computer, a regression based upon the property data, the regression modeling the relationship between the comparable-appropriateness and explanatory variables;
determining a set of comparable-appropriateness values for each of the plurality of comparable properties based upon differences in the explanatory variables between the subject property and each of the plurality of comparable properties; and
outputting an assessment of each of the plurality of comparable properties based upon the determined set of comparable-appropriateness values.

9. A method for automatically rating comparable properties, the method comprising:
means for accessing property data and comparable assessment information that identifies comparable-appropriateness corresponding to the property data;
means for performing a regression based upon the property data, the regression modeling the relationship between the comparable-appropriateness and explanatory variables;
means for identifying a subject property and a plurality of comparable properties;
means for determining a set of comparable-appropriateness values for each of the plurality of comparable properties based upon differences in the explanatory variables between the subject property and each of the plurality of comparable properties; and
means for outputting an assessment of each of the plurality of comparable properties based upon the determined set of comparable-appropriateness values.

10. An apparatus that automatically rates comparable properties, comprising:
a circuit that accesses property data and comparable assessment information that identifies a subject property and a plurality of comparable properties, identifies comparable-appropriateness corresponding to the property data of the subject property and the plurality of comparable properties, performs a regression based upon the property data, the regression modeling the relationship between the comparable-appropriateness and explanatory variables, determines a set of comparable-appropriateness values for each of the plurality of comparable properties based upon differences in the explanatory variables between the subject property and each of the plurality of comparable properties, and outputs an assessment of each of the plurality of comparable properties based upon the determined set of comparable-appropriateness values; and
a display that displays the assessment of each of the plurality of comparable properties.
